(19) United States
(12) Patent Application Publication
(10) Pub. No.: US 2022/0080656 A1
(43) Pub. Date: Mar. 17, 2022

(54) TOOL UNIT

(71) Applicant: AM DESIGN E.U., Wien (AT)

(72) Inventor: Konrad SCHREINER, Wien (AT)

(21) Appl. No.: 17/421,563

(22) PCT Filed: Jan. 7, 2020
(86) PCT No.: PCT/IB2020/050075

§ 371 Date: Jul. 8, 2021

(30) Foreign Application Priority Data
Jan. 9, 2019 (AT) A 60007/2019

(51) Int. Cl. B29C 64/209; B29C 64/232

(52) U.S. Cl. CPC B29C 64/209; B33Y 30/00; B29C 64/232

(57) ABSTRACT

In a tool unit comprising a tool holder and at least one tool, the tool holder being designed for holding the tool and for guided displacement of the tool in an axial direction from a rest position to a working position and back, the tool holder comprises a control region with a control profile, and wherein a control pin is designed to interact with regions offset in the axial direction in the control profile.

The present invention relates to a tool unit comprising a tool holder and at least one tool, the tool holder being designed for holding the tool and for guided displacement of the tool in an axial direction from a rest position to a working position and back, as well as a 3D positioning device with a such tool unit.

The present invention is primarily directed to tool units in the field of 3D positioning devices and in particular in the field of machines for carrying out additive manufacturing processes. Generative manufacturing processes, also known as 3D printing processes, are characterized by the fact that a shaped body is built up in layers. Usually, a working plane is repeatedly traversed line by line or point by point and material is applied in a location-selective manner and the working plane is then shifted upwards. The layer thicknesses are between 0.025 and 1.25 mm or more, depending on the application. The basis for 3D printing processes are computer models of the object to be manufactured, which can be generated, for example, with the aid of CAD software. In this case, a height layer plan of the object to be manufactured is created, in which a production grid is generated for each layer, which defines the cells of the grid on which production material is to be deposited and solidified in a location-selective manner. Using the same principle, however, layers from a solid block of material can also be removed in a location-selective manner, as is the case with CNC milling, for example.

The invention relates in particular to a tool unit for 3D printing processes, which is referred to as Fused Deposition Modeling (FDM) or Fused Filament Fabrication (FFF), in which a shaped body is built up in layers from a meltable plastic. For this purpose, a plastic or wax material (filament), which is usually supplied in the form of a wire from a material supply, is first liquefied by heating and then the liquefied material is applied by extrusion using a nozzle and finally the material is hardened by cooling at the desired position on the working plane. The material can be applied in the form of a strand or a dot.

Mold waxes and thermoplastics such as polyethylene, polypropylene, polylactide, ABS, PETG and thermoplastic elastomers can currently be used for the FDM process.

The filament material is usually heated and extruded by means of a print head, also referred to more generally as a tool in connection with the present invention, which is also referred to as a “hot end”. In conventional FDM processes, the filament is conveyed through a heated chamber of the print head and melted there. The molten material is pressed through the nozzle of the print head or tool with a defined cross section.

3D printing processes are becoming increasingly complex and are no longer used only for prototyping. Rather, such processes are also used to produce ready-to-use components, which as such sometimes have to meet different mechanical and thermal requirements in different regions of the respective component. For this reason, the components have to be manufactured using additive manufacturing processes from different materials that can differ in terms of their color, hardness and impact strength, their temperature resistance or other material properties. The different materials have to be applied with different print heads or tools, as otherwise it would be necessary to empty, clean and refill the print head with each change of material or to load it with the new material, for which the respective print head, for example, with regard to the melting temperature attainable with the print head may not be suitable at all, depending on the respective material. Therefore, 3D positioning devices, in particular 3D printers, have already become known in the prior art, which have a plurality of print heads or tools on a carrier, which are put into operation for the production of a component or workpiece as required in order to print specific sections or regions of the workpiece. For this purpose, the print head used in each case is brought into a working position which is advanced in the axial direction of the printhead in relation to a rest position of the printheads that are currently not in use. This is necessary in order to prevent the printheads that are currently not in use from colliding with the newly applied material layer and damaging it, sticking to the other material or being damaged themselves. In order to ensure rapid processing of different materials, it is already known in the prior art to automatically move the various print heads or tools from the rest position to the working position and to lock them there.

For example, US 2015/0140147 A1 discloses a 3D printer with a tool unit of the type mentioned at the outset, in which a plurality of print heads or tools are arranged on a turret-like tool unit, the respectively required print head first being brought into operative connection with a drive by rotating a tool carrier and then being advanced by the drive. Because of the turret-like tool unit, the tool unit is on the one hand relatively large in terms of its dimensions and on the other hand does not allow the tools, i.e. print heads, to be exchanged quickly.

The present invention is therefore based on the object of improving a tool unit of the type mentioned at the outset in such a way that the tool unit is made smaller and the tools or printing heads can be exchanged quickly and easily in order to implement more compact 3D printers and similar 3D positioning devices, in particular with multiple print heads or working heads.

To achieve this object, a tool unit of the type mentioned at the outset is characterized according to the invention in that the tool holder comprises a control region with a control profile and a control pin is designed to interact with regions offset in the axial direction in the control profile. The interaction of a control pin with a control profile having regions offset in the axial direction allows small-sized means to displace the tool in accordance with the axial offset of the regions that are offset in the axial direction by having the control pin scan the regions offset in the axial direction in the control profile. At the same time, a control pin can be brought into engagement or disengagement from the control region relatively easily, so that the tool can be replaced relatively easily.

According to a first preferred embodiment of the present invention, the tool holder comprises a base body and at least one guide element arranged thereon for moving the at least one tool in the tool holder, wherein in a wall of the at least one guide element at least one control groove for a control pin on the tool for engagement in the control groove is formed, the control groove comprising a control profile running along a circumferential direction of the wall, the control profile comprising at least two regions offset in the axial direction, and wherein a drive means is provided in the tool holder for rotating the at least one guide element in the tool holder.

Because the tool is received in a guide element for axially moving the tool, which at the same time has the displacing means in the form of a control, groove that interacts with a control pin on the tool or print head, the functionalities of the stabilizing guidance of the tool and the effecting of the displacement into the working position or into the rest position can be provided by a single component, namely by the guide element. The guide element is designed to be hollow or essentially tubular for receiving the tool and is therefore able to securely support a tool with a corresponding outer contour against tilting. When the at least one guide element is rotated by the action of the drive means in the tool holder, the control grooves in the wall of the guide element provide for an axial forward and backward movement of the tool or print head in the guide element due to their interacting with the control pin on the tool, which is held in the at least one guide element in a rotationally fixed manner, due to the control section running along the circumferential direction of the wall with the control profile with at least two regions of the control groove offset in the axial direction. Overall, this ensures that the tools are firmly supported, wherein a print head of a 3D printer, for example, can be pushed back and forth easily and automatically and locked in the respective positions through the interaction of the control pin with the control groove.

If the control groove has an axially directed inlet section for the control pin which opens at an edge of the wall, as corresponds to a preferred embodiment of the present invention, such a tool can be easily removed or inserted through the inlet section when the corresponding guide element is in a rotational position in which the control pin can axially enter the inlet section of the control groove or exit from the inlet section.

A number of possibilities are conceivable for driving the at least one guide element to rotate it. However, it is preferred that the drive means is formed by a belt which runs around the at least one guide element and which engages with the at least one guide element. The revolving belt can for example be designed as a V-belt, but preferably as a toothed belt, which is driven by a corresponding motor, wherein the motor unit, which, if necessary, can also be provided with a gear, is preferably attached to the tool holder. The belt preferably runs inside the tool holder.

Alternatively, a preferred embodiment of the present invention provides that the drive means is formed by a driven gearwheel which is geared with the at least one guide element.

The tool unit according to the invention is to be regarded as space-saving and efficient for moving the tool even when used with just one tool. However, the present invention proves to be particularly advantageous if the tool holder comprises a plurality of guide elements, preferably three guide elements and the drive means is designed for synchronously rotating the guide elements, wherein a plurality of guide elements with respect to the regions of the control grooves that are offset in the axial direction relative to the drive means is received in the tool holder offset in the circumferential direction of the guide elements. In this way, when actuating the drive means, for example the belt, all guide elements in the tool holder are rotated simultaneously and synchronously, whereby the control pins of the tools are actuated by the control profiles of the control grooves. If now, as provided, the control profiles are arranged offset accordingly, that is, if the regions of the control profiles offset in the axial direction, which define the working and rest positions in interaction with the control pins of the tools, are arranged in the synchronous rotational movement in such a way that at any time only one tool is in the working position and the other tools are in the rest position, i.e. in a retracted position, all tools of a tool unit according to the invention can be driven to assume the respective work and rest positions with the device according to the invention by simply driving the belt. In addition, rotational positions of the belt can be programmed for each guide element or for each tool in a guide element, which allows a tool to be removed from a respective control groove through the inlet section.

In this context, it is preferred that the drive means is in engagement with a first guide element of the plurality of guide elements and that at least one further guide element of the plurality of guide elements is in engagement with the first guide element. In this way, the first guide element, which is driven directly by the drive means, preferably by a gearwheel, drives the further guide elements, so that a synchronous rotational movement of the plurality of guide elements is achieved.

For better guidance of the tool in the at least one guide element, the invention is preferably further developed to the effect that three identical control grooves are arranged in the at least one guide element, preferably offset by 120° each, in a circumferential direction of the at least one guide element. This ensures that the actuating force is applied evenly around the circumference of a tool, which counteracts tilting and jamming in the guide element.

More precise guidance of the tool in the guide element is achieved when a resilient stop is formed between the tool and the at least one guide element, as corresponds to a preferred embodiment of the present invention. This means that the tool in the control groove is pressed against the upper edge of the control profile, so that a certain amount of play between the control pin and the control groove is eliminated. At the same time, when the rotational position of the guide element is set accordingly, the tool is pressed out of the control profile through the inlet section for removal.

According to an alternative preferred embodiment of the present invention, the control profile is designed as a profiled hole on the tool holder and the profiled hole cooperates with a rotatable profiled control pin on a support element of the tool unit. The tool holder is guided on the support element so as to be displaceable in the axial direction. This alternative way of realizing the present invention is based on the fact that a rotatable control pin, which in turn has a profile and thus an eccentricity, interacts with a profiled hole that, due to its profile, provides a control profile. When rotating, the control profile in the hole is scanned by the control pin, so that the entire tool holder is displaced in the axial direction with respect to the support element of the tool unit. The tool attached to the tool holder is thus also displaced in the axial direction.

The support element preferably comprises a plurality of control pins which are driven by a drive means for synchronous rotation, wherein a tool holder having the profiled hole each cooperates with a control pin. In this way, the plurality of tools or print heads are again synchronously displaced in the axial direction into the working position or into the rest position.

In order to be able to compensate for any manufacturing tolerances, the control pin is resiliently mounted along its axis of rotation, as corresponds to a preferred embodiment of the present invention. This means that the control pin engaging in the profiled hole acts on the tool holder with a spring force and thus presses the tool holder against the support element.

The 3D positioning device according to the invention is designed in particular as a 3D printer and comprises a tool unit according to the invention.

The invention is explained in more detail below with reference to an exemplary embodiment shown in the drawing. In the drawings

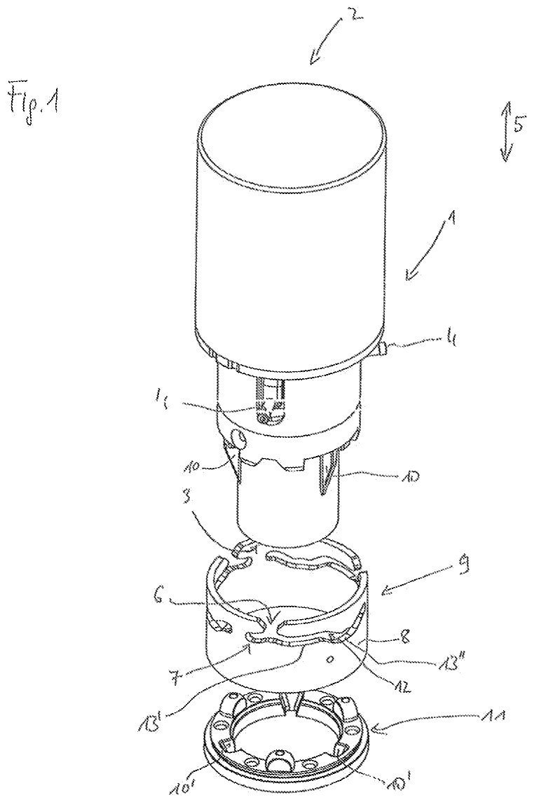

FIG. 1 is a perspective view of a tool, a guide element and an anti-twist device for the tool,

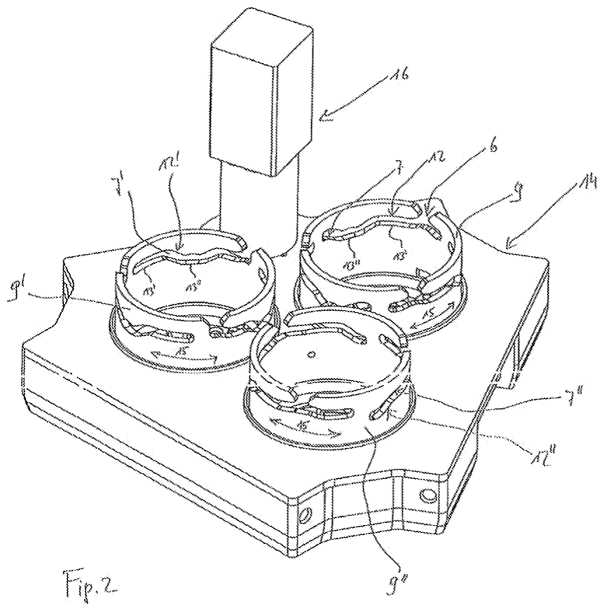

FIG. 2 is a perspective view of a tool holder with three guide elements,

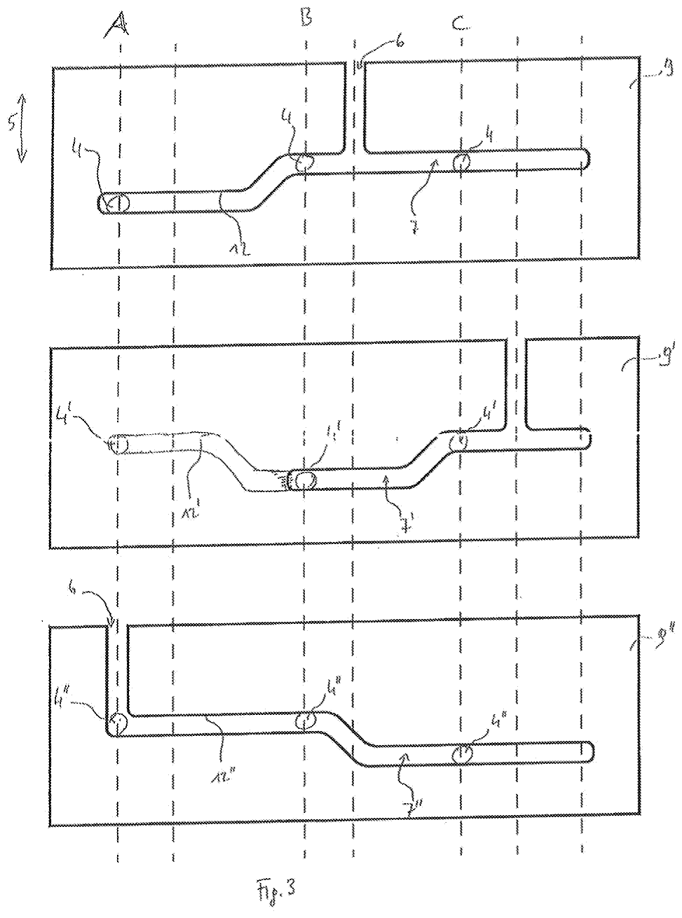

FIG. 3 is a schematic representation of three control grooves for three guide elements or tools,

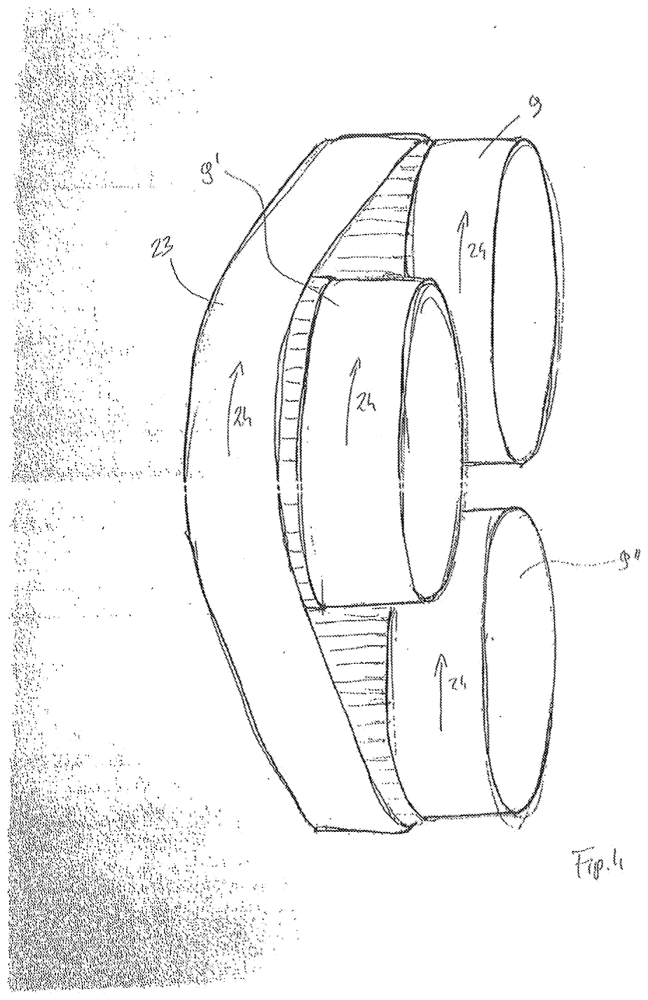

FIG. 4 is an illustration of a drive means for three guide elements,

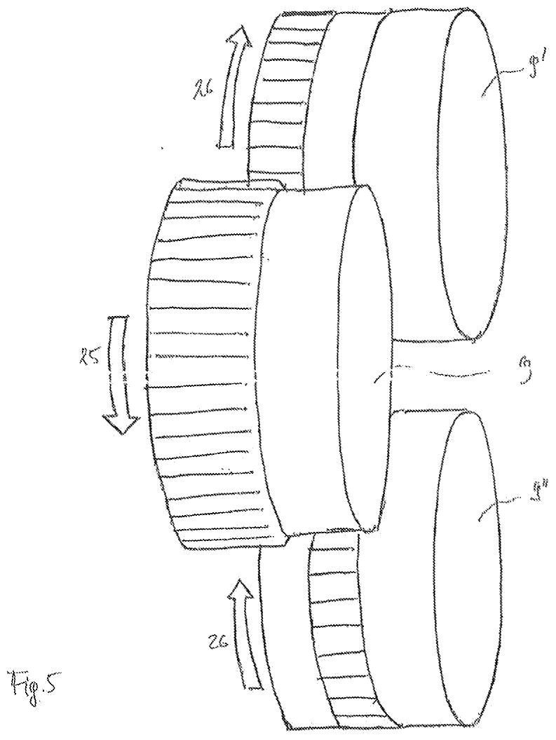

FIG. 5 is a perspective view of an alternative drive means for three guide elements and

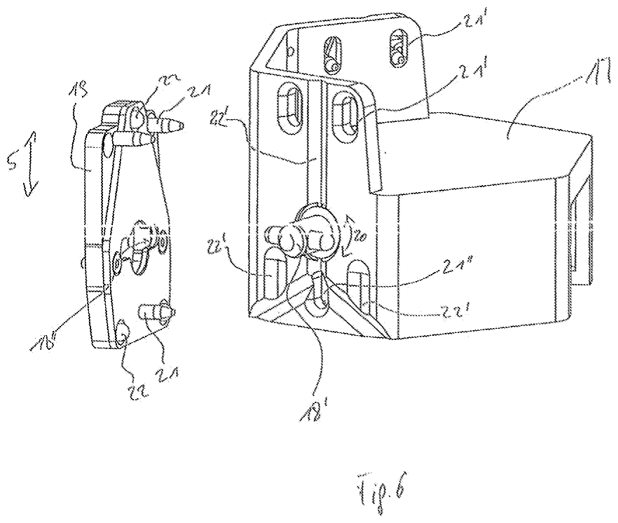

FIG. 6 shows a perspective illustration of an alternative embodiment of a tool unit according to the invention.

In FIG. 1, a tool 1 is designed as a working head or print head 1 for a 3D printer. Filament (not shown) is fed to the print head 1 at a proximal end 2 and the filament is melted in the printhead 1 and released and solidified at the distal end 3 (“hot end”) to build a workpiece in an additive manufacturing process. The tool 1 can also be designed as a cutting tool, for example a CNC milling machine, but this is not shown in the figures.

The print head 1 has three control pins 4, which are arranged around the circumference of the print head 1 and are offset by 120°. The print head 1 can now enter the guide element 9 in the axial direction, which is symbolized by the double arrow 5, by inserting the control pins 4 into the inlet section 6 of the control groove 7 in the wall 8 of the guide element 9. When the print head 1 is inserted into the guide element 9 and with its control pin 4 into the control groove 7, it is secured against rotation in the guide element 9 by the ribs 10, which interact with corresponding recesses 10′ on the anti-rotation device 11, so that the guide element 9 is rotated by the action of the control profile 12 of the control groove 7 to displace the print head 1 or tool 1 in the axial direction 5. The reason for this is that the control profile 12 has areas 13′ and 13″ which are offset in the axial direction and which correspond to different axial positions of the tool 1 in the sense of the double arrow 5. By turning the guide element 9, the control pins 4 of the tool 1 or of the print head 1 pass through the control profile 12 and the print head 1 is pushed forwards or backwards according to the axial positions of the different regions of the control profile 12.

FIG. 2 now shows that the invention can be used in a particularly advantageous manner for moving a plurality of tools or print heads. For this purpose, several guide elements 9, 9′ and 9″ are arranged in a common tool holder 14. The guide elements 9, 9′ and 9″ have mutually different control profiles 12, 12′ and 12″, which with respect to the regions 13′, 13″ of the control grooves 7, 7′, 7″ which are offset in the axial direction with regard to a drive means, which is received in the tool holder 14, are each received in the tool holder 14 offset in the circumferential direction (symbolized by the double arrows 15) of the guide elements 9, 9′ and 9″. The guide elements 9, 9′ and 9″ are driven by the drive means for common and synchronous rotation and the control profiles 12, 12′ and 12″ are oriented to one another in such a way that, depending on the respective rotational position of the drive means, only one tool (not shown in FIG. 2) is in an axially advanced working position, while the other tools are either in a retracted rest position or, if the control pin(s) of the tool is/are aligned with the inlet sections 6, in a release position. Reference numeral 16 designates a drive with a motor and a gear for the drive means.

The fact that has just been described can be better understood when looking at FIG. 3. In a first rotational position or rotational position A of the guide elements 9, 9′ and 9″ in the tool holder, the control pin 4 of a first print head is located in an axially advanced region of the control groove 7. The corresponding print head is thus in a working position. At the same time, the control pin 4′ of a second print head is located in an axially retracted region of the control groove 7′ and the control pin 4″ of a third print head is aligned with the inlet section 6 of the guide element 9″ and is there also in an axially retracted region of the control groove 7″.

In a second rotational position or rotational position B of the guide elements 9, 9′ and 9″ in the tool holder, the control pins 4 and 4″ of the first and third printhead are located in an axially retracted region of the control grooves 7 and 7″ and the corresponding print heads are thus in a rest position. At the same time, however, the control pin 4′ of the second print head is located in an axially advanced region of the control groove 7′ and the print head is thus in a working position.

In a third rotational position or rotational position C of the guide elements 9, 9′ and 9″ in the tool holder, the control pins 4 and 4′ are located in an axially retracted region of the control grooves 7 and 7′ and the corresponding print heads are thus in a rest position. At the same time, however, the control pin 4″ of the third print head is located in an axially advanced region of the control groove 7″ and the print head is thus in a working position.

The further exemplary rotational positions not explicitly designated and shown in dashed lines in FIG. 3 are transition positions or are used to remove or insert print heads. The control grooves 7, 7′ and 7″ in FIG. 3 do not necessarily correspond to those that can be seen in the preceding figures and an abundance of different configurations of the control profiles 12, 12′ and 12″ are conceivable.

In FIG. 4, the drive means is implemented as a toothed belt 23 with inwardly directed teeth. The toothed belt 23 is toothed with the guide elements 9, 9′ and 9″, so that a rotation of the toothed belt in the direction of the arrow 24 leads to a synchronous rotation of the guide elements 9, 9′ and 9″ in the same direction, since with the embodiment shown in FIG. 4 the guide elements 9, 9′ and 9″ are not directly interlocked with one another but are only connected to one another via the toothed belt 23.

Alternatively, the drive means can be formed by a driven gearwheel (not shown) which meshes with a first guide element 9. FIG. 5 relates to this variant and it can be seen that the first guide element 9 in turn engages with the further guide elements 9′ and 9″. When the first guide element 9 rotates in the direction of the arrow 25, the further guide elements 9′ and 9″ perform an opposite and synchronous rotation in the direction of the arrows 26.

FIG. 6 shows how a tool, for example a print head, can be fixed to a support element 17 in order to allow the axial movement to be achieved with the present invention. A rotatable control pin 18′ on the support element 17 interacts with a corresponding profiled hole 18″ in an alternative tool holder 19. The tool holder 19 is pushed with the profiled hole 18″ over the rotatable control pin 18′. Upon rotation of the rotatable control pin 18′ in the direction of the double arrow 20, the profile in the profiled hole 18″ is scanned by the eccentric control bolt 18′, so that a displacement of the tool holder 19 and thus a tool attached to it takes place in the direction of the double arrow 5 and thus in the axial direction. The pins 21 engage in the corresponding elongated holes 21′ or in the groove 21″, which allows movement in the axial direction 5 for moving the print head or generally the tool. Bearing balls 22 press against corresponding grooves 22′ and can also be displaced in the same in the direction of double arrow 5.

1. A tool unit comprising a tool holder and at least one tool, the tool holder being designed for holding the at least one tool and for guided displacement of the at least one tool in an axial direction from a rest position to a working position and back, characterized in that the tool holder comprises a control region with a control profile, and wherein a control pin is designed to interact with regions offset in the axial direction in the control profile.

2. The tool unit according to claim 1, characterized in that the tool holder comprises a base body and at least one guide element arranged thereon for moving the at least one tool in the tool holder, wherein, in a wall of the at least one guide element, at least one control groove for a control pin on the at least one tool for engagement in the at least one control groove is formed, the at least one control groove comprising a groove control profile running along a circumferential direction of the wall, the groove control profile comprising at least two regions offset in the axial direction, and wherein a drive means is provided in the tool holder for rotating the at least one guide element in the tool holder.

3. The tool unit according to claim 2, characterized in that the at least one control groove comprises an axially directed inlet section for the control pin, wherein said inlet section opens at an edge of the wall.

4. The tool unit according to claim 2, characterized in that the drive means is formed by a belt which runs around the at least one guide element and which engages with the at least one guide element.

5. The tool unit according to claim 2, characterized in that the drive means is formed by a driven gearwheel which is toothed with the at least one guide element.

6. The tool unit according to claim 2, characterized in that the tool holder comprises a plurality of guide elements and that the drive means is designed for synchronously rotating the plurality of guide elements, wherein the plurality of guide elements, with respect to the regions of the control grooves that are offset in the axial direction relative to the drive means, is received in the tool holder offset in the circumferential direction of the plurality of guide elements.

7. The tool unit according to claim 6, characterized in that the drive means is in engagement with a first guide element of the plurality of guide elements and that at least one further guide element of the plurality of guide elements is in engagement with the first guide element.

8. The tool unit according to claim 2, characterized in that three identical control grooves are arranged in the at least one guide element and offset by 120° each, in a circumferential direction of the at least one guide element.

9. The tool unit according to claim 2, characterized in that a resilient stop is formed between the at least one tool and the at least one guide element.

10. The tool unit according to claim 1, characterized in that the control profile is designed as a profiled hole on the tool holder and the profiled hole cooperates with a rotatable profiled control pin on a support element of the tool unit.

11. The tool unit according to claim 10, characterized in that the support element comprises a plurality of control pins which are driven by a drive means for synchronous rotation, wherein a tool holder having the profiled hole each cooperates with a control pin.

12. The tool unit according to claim 10, characterized in that the control pin is resiliently mounted along its axis of rotation.

13. A 3D positioning device comprising a tool unit according to claim 1.
